(19) United States
(12) Patent Application Publication
(10) Pub. No.: US 2007/0038766 A1
(43) Pub. Date: Feb. 15, 2007

(54) Computer readable medium and recording medium therefor

(75) Inventor: Yuji Hattori, Nagoya (JP)

Correspondence Address: MCDERMOTT WILL & EMERY LLP, 600 13TH STREET, N.W., WASHINGTON, DC, 20005-3096, US

(73) Assignee: Brother Kogyo Kabushiki Kaisha

(21) Appl. No.: 11/489,589

(22) Filed: Jul. 20, 2006

(30) Foreign Application Priority Data
Jul. 20, 2005 (JP) 2005-210486

(51) Int. Cl. G06F 15/16

(52) U.S. Cl. 709/229

(57) ABSTRACT

A computer readable medium including computer readable instructions is provided. The computer readable instructions cause a computer to execute the steps of obtaining a current time, judging whether the current time is prior to at least one predetermined time, and controlling accessibility of the computer to a piece of device-related data, which is used in cooperation with the computer and is stored in a recording medium, based on a judgment made to determine whether the current time is prior to the at least one predetermined time.

### CROSS REFERENCE TO RELATED APPLICATION

This application claims priority from Japanese Patent Application No. 2005-210486, filed on Jul. 20, 2005, the entire subject matter of which is incorporated herein by reference.

### BACKGROUND

1. Technical Field

Aspects of the invention relate to a computer readable medium to control availability of information relating to devices which are directly or indirectly connected to computers depending on timing to access the information, and a recording medium storing therein the computer readable medium and the information relating to the devices.

2. Related Art

Recently, as personal computers (hereinafter referred to as PCs) have come into wide use, peripheral devices for the PCs, such as printers, have become widely used as well. Generally, in order to operate the peripheral devices in cooperation with the PCs, software such as driver software and application software to drive the peripheral devices are required to be installed in the PCs. The driver software and application software are often included in recording media, such as CD-ROMs, which accompany the peripheral devices. Such a peripheral device operated with driver software is disclosed in Japanese Patent Provisional Publication No. 2004-32403.

Generally, as peripheral devices such as printers are manufactured, a plurality of models for one series are produced over different releasing periods. In such a case, manufacturers of the peripheral devices are required to provide with recording media, such as CD-ROMs, storing driver software and/or accompanying application software therein for each model to be released so that information concerning unreleased models of the peripheral devices will not be undesirably disclosed. That is, the manufacturers are required to provide numbers of versions of the CD-ROMs, which may cause drawbacks in controlling the recording media and cost-efficiency.

### SUMMARY OF THE INVENTION

In view of the foregoing drawbacks, aspects of the present invention are advantageous in that a computer readable medium to control availability of information relating to devices which are connected to computers depending on timing, and a recording medium to store therein the computer readable medium and the information relating to the devices are provided.

### BRIEF DESCRIPTION OF THE ACCOMPANYING DRAWINGS

FIG. 1 shows a block diagram to illustrate a configuration of a PC to read a computer readable medium according to an embodiment of the invention.

FIG. 2 shows a diagram to illustrate a content of a recording medium according to the embodiment of the invention.

FIG. 3 shows a diagram to illustrate a correspondence between scheduled dates and buttons to be displayed according to the embodiment of the invention.

FIG. 4 shows a flowchart to illustrate a process executed by the PC that reads the computer readable medium according to the embodiment of the invention.

FIGS. 5A and 5B illustrate screens to be displayed when a model is selected according to the embodiment of the invention.

FIG. 6 illustrates another screen displayed when a model is selected according to the embodiment of the invention.

FIG. 7 illustrates a screen displayed when information to be obtained is selected according to the embodiment of the invention.

### DETAILED DESCRIPTION

General Overview of Aspects of the Invention

The following describes general aspects of the invention that may or may not be included in various embodiments and modifications. It should be noted that various connections are set forth between elements in the following description. These connections in general and, unless specified otherwise, may be direct or indirect and that this specification is not intended to be limiting in this respect.

According to some aspects of the invention, a computer readable medium including computer readable instructions is provided. The computer readable instructions cause a computer to execute the steps of (1) obtaining a current time, (2) judging whether the current time is prior to at least one predetermined time, and (3) controlling accessibility of the computer to a piece of device-related data, which is used in cooperation with the computer and is stored in a recording medium, based on a judgment made to determine whether the current time is prior to the at least one predetermined time

According to the above configuration, by controlling the accessibility of the device-related data when the current time is prior to the predetermined time, which is, for example, a scheduled release time of the device and when the current time is later than or equal to the predetermined time, which is for example a scheduled release time, a piece of the device-related data corresponding to the device that is not yet released with the scheduled release time is inhibited from being accessed. Further, only a piece of the device-related data that corresponds to the device that has been released can be accessed. Thus, a piece of the device-related data concerning an unreleased device can be protected from being disclosed, and the device-related data for a plurality of devices with different scheduled release times can be stored in one recording medium. Therefore, the recording medium with the device-related data therein can be controlled in a cost-efficient manner.

Optionally, the piece of device-related data may be inhibited from being accessed by the computer when the current time is judged to be prior to the at least one of the predetermined time.

According to the above configuration, by inhibiting the accessibility of the device-related data when the current time is prior to the predetermined time, which is for example a scheduled release time of the device, a piece of the device-related data corresponding to the device that is not yet released with the scheduled release time is inhibited from being accessed. Thus, the piece of the device-related data concerning an unreleased device can be protected from being disclosed, and the device-related data for a plurality of devices with different scheduled release times can be stored in one recording medium. Therefore, the recording medium with the device-related data therein can be controlled in a cost-efficient manner.

Optionally, the piece of device-related data may be released to be accessed by the computer when the current time is judged to be one of later than and equal to the at least one of the predetermined time.

According to the above configuration, by releasing the device-related data to be accessible when the current time is later than or equal to the predetermined time, which is for example a scheduled release time, only a piece of the device-related data that corresponds to the device that has been released can be accessed. Thus, a piece of the device-related data concerning an unreleased device can be protected from being disclosed, and the device-related data for a plurality of devices with different scheduled release times can be stored in one recording medium. Therefore, the recording medium with the device-related data therein can be controlled in a cost-efficient manner.

Optionally, the recording medium may store a plurality of pieces of the device-related data, each of which is related one of a plurality of devices being used in cooperation with the computer and corresponds to one of a plurality of the predetermined times. Each of the plurality of the predetermined times may be compared to the current time in a counter-chronological order from a time scheduled to be a last-to-come to a time scheduled to be a first-to-come in a time sequence among all the plurality of the predetermined times when the judgment is made. One of the pieces of the device-related data corresponding to the one of the plurality of the predetermined times that is judged to be one of later than and equal to the current time in the judgment may be inhibited from being accessed by the computer.

According to the above configuration, by comparing each of the plurality of the predetermined times, which is for example a scheduled release time, to the obtained current time in the counter-chronological order, a piece of the device-related data that corresponds to the device that has not been released can be inhibited from being accessed. Thus, a piece of the device-related data concerning an unreleased device can be protected from being disclosed and the device-related data for a plurality of devices with different scheduled release times can be stored in one recording medium. Therefore, the recording medium with the device-related data therein can be controlled in a cost-efficient manner.

Optionally, the recording medium may store a plurality of pieces of the device-related data, each of which is related one of a plurality of devices being used in cooperation with the computer and is corresponded to one of a plurality of the predetermined times. Each of the plurality of the predetermined times may be compared to the current time in a counter-chronological order from a time scheduled to be a last to come to a time scheduled to be a first to come in a time sequence among all the plurality of the predetermined times when the judgment is made. One of the pieces of the device-related data corresponding to the one of the plurality of the predetermined times that is judged to be prior to the current time in the judgment may be released to be accessed by the computer.

According to the above configuration, by comparing each of the plurality of the predetermined times, which is for example a scheduled release time, to the obtained current time in the counter-chronological order, only a piece of the device-related data that corresponds to the device that has been released can be accessed. Thus, a piece of the device-related data concerning an unreleased device can be protected from being disclosed, and the device-related data for a plurality of devices with different scheduled release times can be stored in one recording medium. Therefore, the recording medium with the device-related data therein can be controlled in a cost-efficient manner.

Optionally, each of the plurality of pieces of the device-related data may be corresponded to one of a plurality of models that belong to one product series of the devices being used in cooperation with the computer.

Such models of devices that belong to one product series are generally produced and released in sequence according to a releasing schedule, and each of the models are provided with a piece of the device-related data. According to the above configuration, the plurality of pieces of the device-related data can be stored in one recording media along with the above-described computer readable medium, so that the plurality of pieces of the device-related data related to the models that belong to the same product series can be collectively administrated. It should be noted that the product series in the invention refers to a variation of the devices that are produced to share identical properties, or produced in one scheme. Further, the model refers to a type of the device that can be distinguished from the others by a structure and form thereof.

Optionally, information corresponding to the piece of the device-related data that is inhibited from being accessed by the computer may be prohibited from being displayed in a display unit of the computer.

According to the above configuration, by prohibiting the information from being displayed, when the predetermined time is a scheduled release time, for example, existence of the device-related data that is corresponded to an unreleased model of the device in the recording medium cannot be known to a user. Thus, the device-related data of the unreleased model can be protected from being undesirably disclosed.

Optionally, the piece of device-related data may include at least one of driver-related data, which is adapted to operate the device through the computer document data, which is adapted to display an operation instruction of the device corresponding to the piece of device-related data on the display unit of the computer, and accompanying application-related data, which runs on the computer when the device corresponding to the piece of device-related data is operated in cooperation with the computer.

Optionally, the one of the predetermined times may include at least one of a scheduled manufacturing time, or a scheduled shipping time, a sales-release time, a press-release time, a scheduled posting time on an internet site.

According to some aspects of the invention, a recording medium storing predetermined data and a computer readable medium including computer readable instructions is provided. The computer readable medium causes the computer to execute the steps of (1) obtaining a current time, (2) judging whether the current time is prior to at least one predetermined time, and (3) controlling accessibility of the computer to a piece of device-related data, which is used in cooperation with the computer and is stored in a recording medium, based on a judgment made to determine whether the current time is prior to the at least one predetermined time

Optionally, the recording medium may further store a plurality of pieces of the device-related data. Each of the plurality of pieces of the device-related data may be related to one of a plurality of devices that are used in cooperation with the computer.

Optionally, each of the plurality of pieces of the device-related data may correspond to one of a plurality of models that belong to one product series of the device being used in cooperation with the computer.

Optionally, the piece of the device-related data may include at least one piece of driver-related data, which operates the device through the computer document data, which displays an operation instruction of the device on a display unit of the computer, and accompanying application-related data, which runs on the computer when the device is operated in cooperation with the computer.

According to the above configuration, the device-related data that corresponds to an unreleased model of the device can be protected from being undesirably disclosed. Thus, the device-related data for a plurality of devices with different scheduled release times can be stored in one recording medium. Therefore, the recording medium with the device-related data therein can be controlled in a cost-efficient manner.

### Embodiment

Hereinafter, referring to the accompanying drawings, an image-forming apparatus, a computer, and a communication system according to an embodiment of the invention will be described.

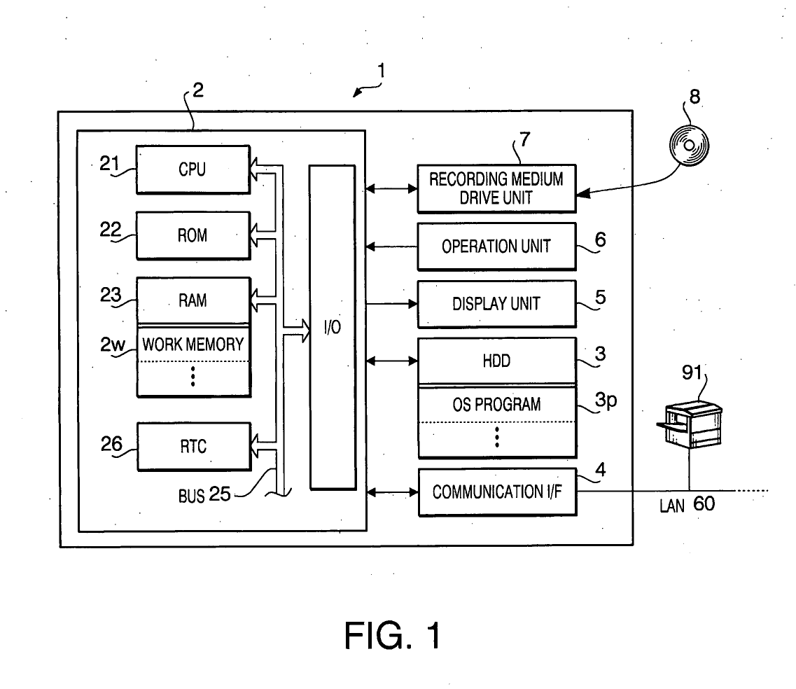

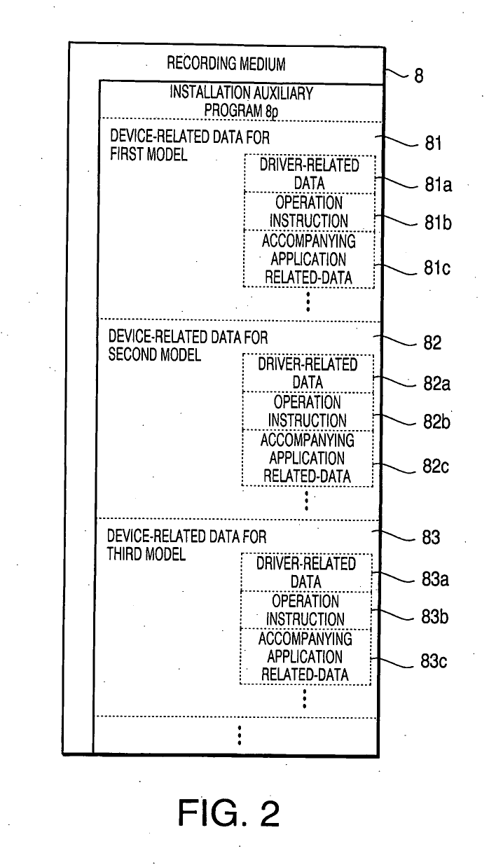

Hereinafter, referring to FIG. 1, a configuration of a PC 1 that reads an installation auxiliary computer readable medium 8p (see FIG. 2) from the recording medium 8 will be described. FIG. 1 shows a block diagram to illustrate a configuration of the PC 1 to read a computer readable medium according to an embodiment of the invention. As shown in FIG. 1, the PC 1 is a known personal computer, having an HDD (hard disk drive) 3, a communication I/F (interface) 4, a display unit 5, an operation unit 6, and a recording medium drive unit 7, which are connected to a controlling circuit 2.

The HDD 3 stores therein an OS (operating system) computer readable medium 3p, which serves as a known operating system to operate the PC 1.

The communication I/F 4 includes a network adapter, which is configured to provide interface functionality between the PC 1 and a LAN (local area network) 60, so that the PC 1 can communicate with external devices connected to the LAN 60, such as the printer 91.

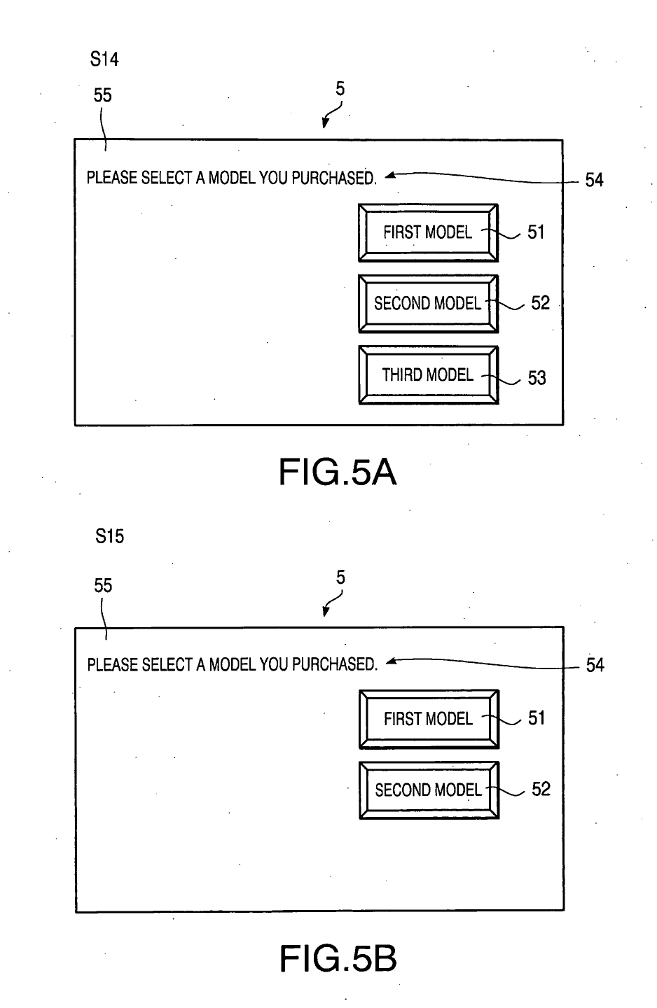

The display unit 5 includes a displaying system such as a liquid crystal display or a CRT (cathode-ray tube) display. The display unit 5 is adapted to display GUI (graphical user interface) in correspondence to a user's operation inputted though the operation unit 6. In a displaying process to display model selection buttons (see FIG. 4), which will be described in detail herein below, the model selection buttons 51, 52, 53 are displayed in a selection screen 55 (see FIG. 5A).

The operation unit 6 includes an inputting system, such as a pointing device (for example, a mouse) and a keyboard. The model selection buttons 51, 52, 53 displayed on the selection screen 55 are selected in accordance with the user's operation to the operation unit 6.

The recording medium drive unit 7 (i.e., a CD-ROM drive in the present embodiment) is adapted to drive a recording medium such as a CD-ROM, a DVD-ROM, or a memory card, so that various data stored in the recording medium is inputted to the PC 1. The recording medium 8 (see FIG. 2) including the installation auxiliary computer readable medium 8p and device-related data 81-83, which will be described in detail hereinbelow, is driven by the recording medium drive unit 7.

As shown in FIG. 1, the controlling circuit 2 includes a CPU 21, a ROM 22, a RAM 23, an I/O (input/output) interface 24, which are connected to a bus 25. The CPU 21 is adapted to control various processes based on the OS computer readable medium 3p, which is stored in the HDD 3. The OS computer readable medium 3p is adapted to be run in a work memory (i.e., a work area) 2w for the OS of the RAM 23. The installation auxiliary computer readable medium 8p is adapted to be run on the OS computer readable medium 8p as the installation auxiliary computer readable medium 8p is read through the recording medium drive unit 7. Further, the controlling circuit 2 is provided with a RTC (real time clock) 26. The OS computer readable medium 8p obtains a current time from the RTC 26 so that the controlling circuit 2 can control the PC 1 based on the timing.

The printer 91 is connected to the LAN 60, so that data for printing can be exchanged between the printer 91 and the PC 1 when the printer 91 receives a print instruction from the PC 1. As described above, in order to operate the printer 91 in accordance with the instruction from the PC 1, the printer 91 is required to have the driver software, accompanying application software, or the like installed therein. It should be noted that, in the present embodiment, the printer is connected to the PC 1 indirectly via the LAN 60, however, the printer may be connected to the PC 1 via a parallel I/F (not shown) or a USB I/F (not shown) equipped to the PC 1.

Hereinafter, referring to FIG. 2, the recording medium 8 according to the present embodiment will be described. FIG. 2 shows a diagram to illustrate a content of the recording medium 8 according to the embodiment of the invention. The recording medium (i.e., a CD-ROM in the present embodiment) 8 stores therein a plurality of pieces of device-related data 81-83, and the installation auxiliary computer readable medium 8p. It should be noted that in the present embodiment the printer 91 is manufactured as one of a plurality of models that belong to a series of printers, and each piece of the device-related data 81-83 is related to one of the models respectively.

The device-related data 81-83 respectively include driver-related data 81a-83a, which is used to operate the printer 91 via the PC 1. Each of the driver-related data 81a-83a includes, for example, data as driver software, and installer (a set-up computer readable medium), which is adapted to copy the driver software into the HDD 3 and set up the PC 1.

The device-related data 81-83 further include document data 81b-83b, which is used to indicate an operation instruction of the printer 91 in the display unit 5 of the PC 1. The document data 81b-83b are, for example, PDF (portable document format) data and text data in which the operation instruction of the printer 91 is described.

The device-related data 81-83 further include accompanying application-related data 81c-83c, which is used when the accompanying application software is run on the PC 1 as the printer 91 is operated. The accompanying application-related data 81c-83c include, for example, data as the accompanying application software, and installer (a set-up computer readable medium), which copies the accompanying application software in the HDD 3 and sets up the PC 1.

It should be noted that, the installation of the installation auxiliary computer readable medium 8p refers to general processes of the PC 1 that reads the device-related data stored in the recording medium 8. That is, in terms of the driver-related data 81a-83a and the accompanying application-related data 81c-83c, the installation refers to processes to read the data from the recording medium 8 and to set up the data in the PC 1. Further, in terms of the document data 81b-83b, the installation refers to processes to read the data from the recording medium 8 and to display document corresponding to the data in the display unit 5 of the PC 1.

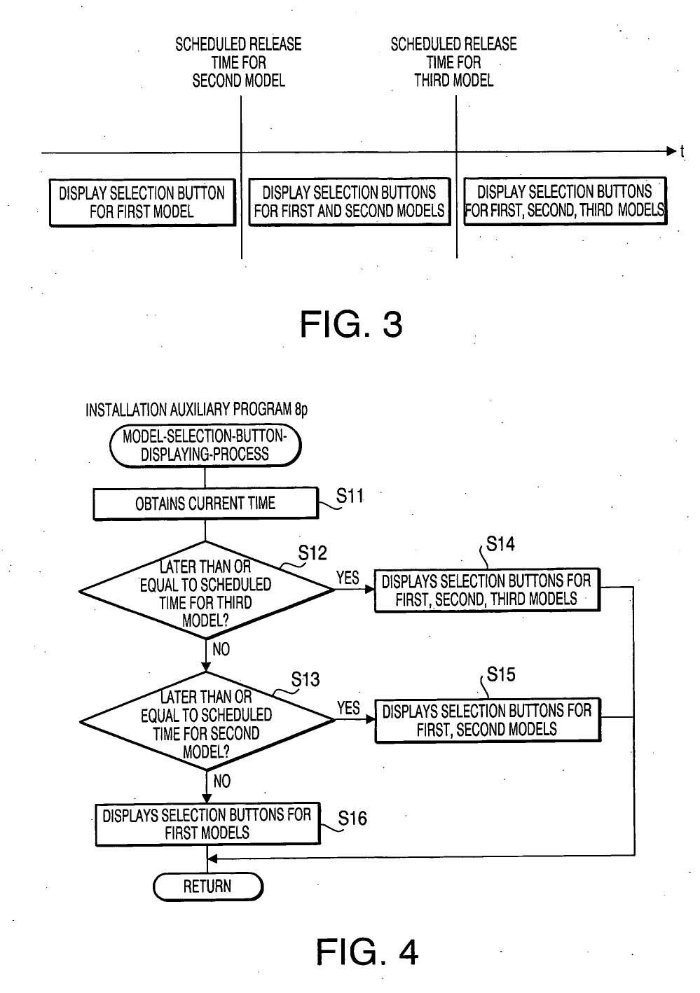

Hereinafter, referring to FIGS. 3-7, a process to be executed in the installation auxiliary computer readable medium 8p will be described. FIG. 4 shows a flowchart to illustrate a model selection-button-displaying-process executed by the PC 1 that reads the installation auxiliary computer readable medium 8p according to the embodiment of the invention. As the CPU 21 of the PC 1 reads the installation auxiliary computer readable medium 8p from the recording medium 8 through the recording medium drive unit 7, the model-selection-button displaying-process is started, so that the user is prompted to select a model of the printer 91 that is connected to the PC 1 and device-related data that is related to the selected model.

FIG. 3 shows a diagram to illustrate a correspondence between the scheduled release times of the models and model selection buttons to be displayed according to the embodiment of the invention. The printer 91 in the present embodiment is manufactured as one of a first model, a second model, and a third model of a series of printers. The first model, the second model, and the third model are respectively scheduled to be released in a chronological order (i.e., the first model is released firstly, the second model is released secondly, and the third model is released thirdly). In the model-selection-button-displaying process, model selection buttons 51, 52, 53 which have not been displayed are selectively displayed based on the release times of each model. Each of the first, second and the third model selection buttons 51, 52, 53 is linked to a selection screen 55b (see FIG. 7), in which one of model selection buttons 51a-51c is selected.

When the model-selection-button-displaying process is started, the CPU 1 obtains the current time from the RTC 26 (S11: a time-obtaining step), and the process proceeds to S12. It should be noted that the current time may also be obtained from an NTP (network time protocol) server on the network.

In S12, the process examines whether the obtained current time is later than or equal to a scheduled release time of one of the models (S12: a judging step). More specifically, the process examines one scheduled release time among a plurality of scheduled release times in a “counter-chronological order” from a release time scheduled to be a last-to-come in a time sequence to a release time scheduled to be a first-to-come in the time sequence. That is, in S12, whether a scheduled release time for the third model is passed is examined. The judgment is made based on a comparison result between the current time and the scheduled release time.

When the process determines that the current time is later than or equal to the scheduled release time for the third model (S12: YES), the process proceeds to S14, wherein the device-related data 83 for the third model is released to be available to the user.

In S14, a model selection button 53 is displayed on the selection screen 55. Simultaneously, the model selection button 52, which corresponds to the scheduled release time for the second model, is displayed on the selection screen 55. Further, the model selection button 51, which corresponds to the release time for the first model, is displayed on the selection screen 55. It should be noted that a release time for the first model is not included as a scheduled release time, as the first model is primarily released to market along with the recording medium 8 storing the device-related data 81-83 and the installation auxiliary computer readable medium 8p therein. The process returns thereafter.

In S12, when the process determines that the current time is not later than or equal to the scheduled release time for the third model (S12: NO), the process proceeds to S13.

In S13, the process examines the scheduled release time for the second model according to the counter-chronological order. When the process determines that the current time is later than or equal to the scheduled release time for the second model (S113: YES), the process proceeds to S15, wherein the device-related data 82 for the second model is released to be available to the user.

In S15, more specifically, a model selection button 52 is displayed on the selection screen 55. Simultaneously, the model selection button 51, which corresponds to the release times for the first model, is displayed on the selection screen 55. It should be noted that, in this step, the model selection button 53 is not displayed on the selection screen 55 (see FIG. 5B), as the scheduled release time for the third model is determined to be later than or equal to the current time in S12 (i.e., the current time is prior to the scheduled release time for the third model). The process returns thereafter.

In S13, when the process determines that the current time is not later than or equal to the scheduled release time for the second model (S13: NO), the process proceeds to S16. In S16, the process restricts the availability of the device-related data 82 for the second model, so that the model selection button 52, as well as the model selection button 53, is not displayed on the selection screen 55 (see FIG. 5B). The process returns thereafter.

FIG. 5A illustrates the selection screens 55 to be displayed in S14 when one of the models is selected according to the embodiment of the invention. FIG. 5B illustrates the selection screens 55 to be displayed in S15 when one of the models is selected according to the embodiment of the invention. In S14 and S15, a message 54 that prompts the to select one of the models is displayed in the selection screen 55. Further, the model selection button 51 for the first model, the model selection button 52 for the second model, and the model selection button 53 for the third model are displayed in S14. It should be noted that the model selection button 53 for the third model is not displayed in S15 (see FIG. 5B), as the device-related data 83 corresponding to the third model is not released at this point of time.

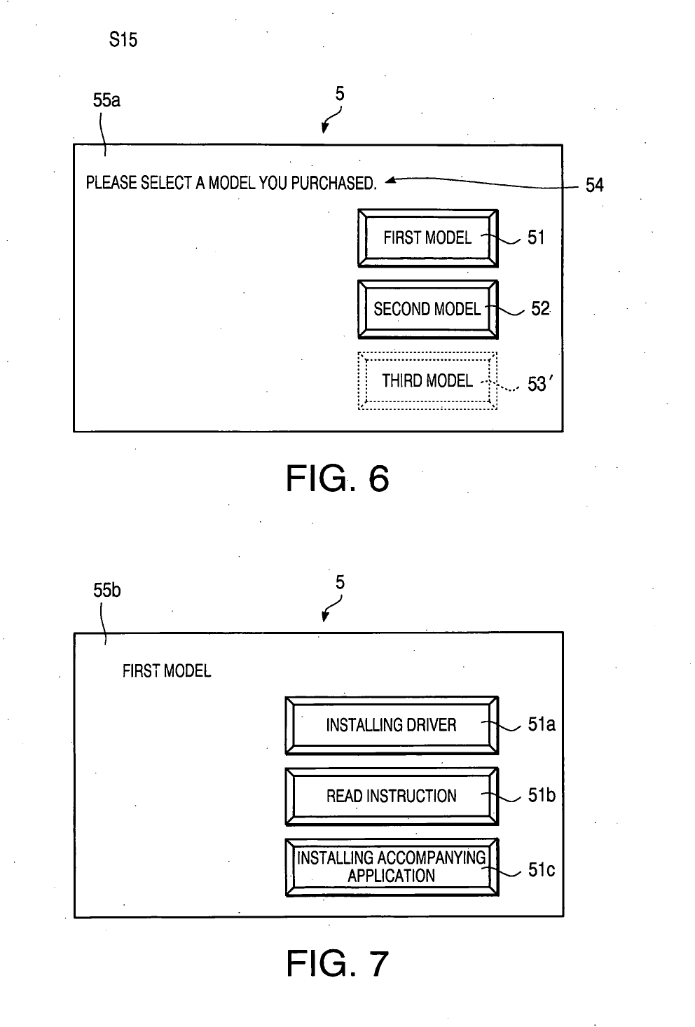

The model selection buttons 51, 52, 53 are respectively linked to another selection screen 55b (see FIG. 7), wherein more specific data (i.e., the driver-related data 81a-83a, the document data 81b-83b, the accompanying application-related data 81c-83c) that are related to the printer 91 is selected. In S15, while the model selection button 53 is restricted from being displayed, the model selection button 53 may be displayed as an unlinked button 53′ as shown in FIG. 6. FIG. 6 illustrates a selection screen 55a as a variation of the selection screen 55, which is to be displayed when one of the models is selected according to the embodiment of the invention. The model selection button 53′ is displayed in a semi-transparent image, and is not linked to the more specific data (i.e., the driver-related data 83a, the document data 83b, the accompanying application-related data 83c), so that the user cannot select the model selection button 53′ to access the more specific data related to the third model.

When the model-selection-button-displaying process ends, the control circuit 2 awaits an input operation through the operation unit 6 to select one of the model selection buttons 51, 52, 53 (the third model is selectable when the process ends after S14). As one of the buttons is selected, a data selection screen 55b linked to the selected button is displayed. FIG. 7 illustrates the data selection screen 55b to be displayed when the model selection button 51 is selected according to the embodiment of the invention. In the data selection screen 55b, the more specific data (i.e., the driver-related data 81a-83a, the document data 81b-83b, the accompanying application-related data 81c-83c) corresponding to the selected button (the selected model) is selected.

As shown in FIG. 7, an installation button 51a for installing the driver software of the first model, an instruction button 51b for showing an operation instruction for the first model, and an installation button 51c for installing accompanying application software are displayed in the data selection screen 55b. In the present embodiment, the installation button 51b is labeled as “installing driver”, the instruction button 51b is labeled as “read instruction”, and the installation button 51c is labeled as “installing accompanying application”. As the installation button 51a is selected, an installer software for the driver-related data 81a of the first model is activated, and the driver software is installed. Similarly, as the installation button 51c is selected, an installer software for the accompanying application-related data 81c of the first model is activated, and the driver software is installed. When the instruction button 51b is selected, the document data 81b is read from the recording medium 8, and the operation instruction of the first model of the printer 91 is shown on a screen (not shown) in the display unit 5.

According to the installation auxiliary computer readable medium 8p in the present embodiment, the device-related data for a predetermined model of a device is disallowed to be referred to (accessed) before a scheduled release time is passed by restricting a model selection button for the model from being displayed. Once the scheduled release time is passed, the device-related data for the predetermined model is allowed to be referred to (accessed) by allowing the model selection button for the model to be displayed. With this configuration, device-related data concerning unreleased models of the device will not be undesirably disclosed. Therefore, the device-related data concerning a plurality of models that are scheduled to be released in different timing can be stored in one recording medium, so that the recording medium can be released to market prior to the scheduled release times, and the recording medium with the device-related data therein can be controlled in a cost-efficient manner.

Although examples of carrying out the invention have been described, those skilled in the art will appreciate that there are numerous variations and permutations of the computer readable medium and the recording medium that fall within the spirit and scope of the invention as set forth in the appended claims. It is to be understood that the subject matter defined in the appended claims is not necessarily limited to the specific features or act described above. Rather, the specific features and acts described above are disclosed as example forms of implementing the claims.

It should be noted that, for example, the peripheral device to be connected to the PC 1 is not necessarily the printer 91, but may be a facsimile machine, a scanner device, and a router, for example. For another example, the scheduled release time of the above embodiment may be a scheduled production date, a scheduled shipping date, a scheduled time for a press release, a scheduled posting time on a web site to show the device, and so on.

What is claimed is:

1. A computer readable medium including computer readable instructions that cause a computer to execute the steps of:
obtaining a current time;
judging whether the current time is prior to at least one predetermined time; and
controlling accessibility of the computer to a piece of device-related data, which is used in cooperation with the computer and is stored in a recording medium, based on a judgment made to determine whether the current time is prior to the at least one predetermined time.

2. The computer readable medium according to claim 1 wherein the piece of device-related data is inhibited from being accessed by the computer when the current time is judged to be prior to the at least one of the predetermined time.

3. The computer readable medium according to claim 1 wherein the piece of device-related data is released to be accessed by the computer when the current time is judged to be one of later than or equal to the at least one of the predetermined time.

4. The computer readable medium according to claim 2,
wherein the recording medium stores a plurality of pieces of the device-related data, each of which is related to one of a plurality of devices being used in cooperation with the computer and corresponds to one of a plurality of the predetermined times,
wherein each of the plurality of the predetermined times is compared to the current time in a counter-chronological order from a time scheduled to be a last-to-come to a time scheduled to be a first-to-come in a time sequence among all the plurality of the predetermined times when the judgment is made, and,
wherein one of the pieces of the device-related data corresponding to the one of the plurality of the predetermined times that is judged to be one of later than or equal to the current time in the judgment is inhibited from being accessed by the computer.

5. The computer readable medium according to claim 3,
wherein the recording medium stores a plurality of pieces of the device-related data, each of which is related to one of a plurality of devices being used in cooperation with the computer and is corresponded to one of a plurality of the predetermined times,
wherein each of the plurality of the predetermined times is compared to the current time in a counter-chronological order from a time scheduled to be a last-to-come to a time scheduled to be a first-to-come in a time sequence among all the plurality of the predetermined times when the judgment is made, and
wherein one of the pieces of the device-related data corresponding to the one of the plurality of the predetermined times that is judged to be prior to the current time in the judgment is released to be accessed by the computer.

6. The computer readable medium according to claim 4 wherein each of the plurality of pieces of the device-related data corresponds to one of a plurality of models that belong to one product series of the devices being used in cooperation with the computer.

7. The computer readable medium according to claim 5 wherein each of the plurality of pieces of the device-related data corresponds to one of a plurality of models that belong to one product series of the devices being used in cooperation with the computer.

8. The computer readable medium according to claim 2 wherein information corresponding to the piece of the device-related data that is inhibited from being accessed by the computer is prohibited from being displayed on a display unit of the computer.

9. The computer readable medium according to claim 2 wherein the piece of device-related data includes at least one of driver-related data, which operates the device through the computer, document data, which displays an operation instruction of the device corresponding to the piece of device-related data on the display unit of the computer, and accompanying application-related data, which runs on the computer when the device corresponding to the piece of device-related data is operated in cooperation with the computer.

10. The computer readable medium according to claim 3 wherein the piece of device-related data includes at least one of driver-related data, which is adapted to operate the device through the computer, document data, which is adapted to display an operation instruction of the device corresponding to the piece of device-related data on the display unit of the computer, and accompanying application-related data, which runs on the computer when the device corresponding to the piece of device-related data is operated in cooperation with the computer.

11. The computer readable medium according to claim 2 wherein the one of the predetermined times includes at least one of a scheduled manufacturing time, a scheduled shipping time, a sales-release time, a press-release time, or a scheduled posting time on an internet site.

12. The computer readable medium according to claim 3, wherein the one of the predetermined times includes at least one of a scheduled manufacturing time, a scheduled shipping time, a sales-release time, a press-release time, or a scheduled posting time on an internet site.

13. A recording medium storing predetermined data and a computer readable medium including computer readable instructions, the computer readable medium causing the computer to execute the steps of:
obtaining a current time;
judging whether the current time is prior to at least one predetermined time; and
controlling accessibility of the computer to a piece of device-related data, which is used in cooperation with the computer and is stored in the recording medium, based on a judgment made to determine whether the current time is prior to the at least one predetermined time.

14. The recording medium according to claim 13, further storing a plurality of pieces of the device-related data wherein each of the plurality of pieces of the device-related data is related to one of a plurality of devices that are used in cooperation with the computer.

15. The recording medium according to claim 14 wherein each of the plurality of pieces of the device-related data corresponds to one of a plurality of models that belong to one product series of the device being used in cooperation with the computer.

16. The recording medium according to claim 13 wherein the piece of the device-related data includes at least one of driver-related data, which is adapted to operate the device through the computer, document data, which displays an operation instruction of the device on a display unit of the computer, and accompanying application-related data, which runs on the computer when the device is operated in cooperation with the computer.
